(19) United States
(12) Patent Application Publication
(10) Pub. No.: US 2002/0157816 A1
(43) Pub. Date: Oct. 31, 2002

(54) Metal heat exchanger tank and method of forming same

(76) Inventor: William D. Curtindale JR., Belleville, MI (US)

Correspondence Address: John S. Artz, 28333 Telegraph Road, Ste. 250, Southfield, MI, 48304, US

(21) Appl. No.: 09/843,306

(22) Filed: Apr. 25, 2001

(51) Int. Cl. F28F 9/02; B23P 15/26; B21D 51/38

(52) U.S. Cl. 165/173; 29/890.052

(57) ABSTRACT

A heat exchanger (10), such as a radiator, includes a metal tank (12) having a foot (28) that is integrally formed therewith. The heat exchanger (10) also includes a header (14) having a plurality of crimping tabs (44) extending therefrom. The integral foot (28) of the metal tank (12) has an upper surface (30) and a lower surface (32) with the lower surface (32) intended to rest within an internal channel (46) formed in the header (14). The crimping tabs (44) are folded around the footer (28) so as to lie above and generally parallel to the footer upper surface (30) in order to retain the metal tank (12) in proper alignment with the header (14). After the metal tank (12) and the header (14) are physically assembled, they are sealed to form a leak-free joint.

### TECHNICAL FIELD

The present invention relates generally to a metal end tank design for a heat exchanger and, more particularly, to a metal end tank for a heat exchanger having an integral foot formed around the perimeter of the tank to allow for easy assembling of the tank to an associated header.

### BACKGROUND ART

Automobile radiators have typically been manufactured from copper and brass with brass being utilized for the headers, tubes, tanks, and connectors, and copper being utilized for the fins. Further, either steel or brass was utilized for the side channels and brackets. These components were typically joined through soldering. As is known, soldering is largely labor intensive, and allows for easy re-working of joints, as solder can be used to fill large gaps which were characteristic of poor manufacturing tolerances. The typical tank-to-header joint included a tank with a straight wall mated to the straight inner wall of the header. With this configuration, a very thin channel would typically remain in the header into which the tank wall would slide. This channel would then be flooded with solder to fill the surrounding joint area until there were no more leaks. These copper and brass radiators were extremely heavy and not very durable.

Subsequently, brazed aluminum radiators were proposed in an effort to reduce the cost and weight of the prior copper and brass radiators. While the aluminum radiators were lighter, had comparable heat transfer properties, and increased life, there were technical concerns relating to cleaning, brazing and corrosion by either environmental conditions or by the coolant itself. These issues were subsequently overcome and robust, low-cost, manufacturing processes for brazing aluminum automobile heat exchangers were developed. However, other problems still existed with these processes, including the inability to effectively draw aluminum to make the same style tanks as has been done previously with brass. Moreover, it was also determined that the attainable manufacturing tolerances were nowhere near what was necessary to consistently braze, leak-free joints. Thus, the manufacturing processes or tolerances, which were satisfactory for copper and brass radiator components, were not sufficient to meet the demands of the aluminum brazing process. Thus, these designs were unacceptable due to the inability to properly draw deep-walled aluminum tanks suitable for automobile radiators, as well as the inability to achieve leak-free brazing.

As an alternative, plastic injection molded tanks were developed. These plastic tanks utilized an intermediary gasket, or seal, and a header crimping mechanism to provide the joining and sealing force. The injection molded tanks also provided the ability to mold-in any needed connectors, filler necks, and brackets, which alleviated the need to fabricate those pieces individually. The plastic end tanks were, however, prone to cracking, especially at the hose connector locations and particularly under extreme temperature conditions or in applications over rough terrain where the heat exchanger is subjected to continuous harsh vibratory conditions. The susceptibility to cracking also posed another manufacturing problem, in that the crimping operation was not very tolerant to variation, so the crimping operation itself could result in many cracked tanks.

Efforts to solve the drawing problems present with aluminum tanks, as discussed above, were proposed. In so doing, these designs attempted to minimize joint clearances by using a straight-wall tank design similar to that which had been used in copper and brass radiators. While some of these designs could be successfully brazed, it was determined that the aluminum headers would often fail prematurely due to fracturing at the pinch point of the very thin channel.

Presently, the reliable method of achieving a successful joint and making a good radiator is to cut the tabs off of a tabbed header and to weld the tank to the header. With a flat spot normally reserved for a gasket and a more suitable radius, the plastic tank radiator headers typically do not fail, even after having an aluminum tank welded thereto. This method is still disadvantageous as it is expensive, suffers from irregularities, and requires labor intensive hand welding of tanks.

Recently, there have been attempts to stray from the traditional shape of the radiator tank in an effort to provide a more efficient process. Some of these attempts included utilizing single or multiple extrusions which, when joined, together serve as the tank and the header. These attempts produced a trade-off in terms of clearance issues in the vehicle, ease of locating mounting brackets, and reduced tank capacity. Moreover, the extrusion process tended to be very expensive and very limiting.

Thus, there remains a need for a low cost radiator design that is easy to manufacture and provides the requisite strength and sealability.

### SUMMARY OF THE INVENTION

It is therefore an object of the present invention to provide a metal end tank for a heat exchanger that provides interchangeability with both current design headers and newer generation design headers.

It is a further object of the present invention to provide a method of attaching a metal end tank to a heat exchanger which assures proper contact and alignment of the components prior to sealing, such as through brazing.

It is another object of the present invention to provide a metal end tank for a heat exchanger that can quickly and efficiently be integrated with current manufacturing processes in a rapid and cost-effective manner.

It is a still another object of the present invention to provide a metal end tank for a heat exchanger that provides superior recyclability attributes, superior crash worthiness, and superior durability.

It is yet a further object of the present invention to provide a metal end tank for a heat exchanger that yields increased product life over current products without adding significant additional weight.

In accordance with the above and other objects of the present invention, a metal end tank heat exchanger is provided. The heat exchanger includes a metal tank having a foot that is integrally formed therewith. The heat exchanger also includes a header having a plurality of crimping tabs extending therefrom. The integral foot of the metal tank is intended to rest within an internal channel in the header when assembled. The crimping tabs are intended to be folded to retain the metal tank in position with respect to the header. After the metal tank and the header are physically assembled, they are sealed to form a leak-free joint.

Additional features and advantages of the present invention will become apparent to one of skill in the art upon consideration of the following detailed description of the present invention.

### BRIEF DESCRIPTION OF THE DRAWINGS

FIG. 1 is a top view of a heat exchanger in accordance with a preferred embodiment of the present invention;

FIG. 2 is a front view of the heat exchanger of FIG. 1;

FIG. 3 is an exploded front view of a heat exchanger in accordance with a preferred embodiment of the present invention;

FIG. 4 is an exploded frontal view of a heat exchanger in accordance with another embodiment of the present invention;

FIG. 5 is an exploded side view of the heat exchanger of FIG. 4;

FIG. 6 is an enlarged view illustrating the crimping of the header to the footer of the tank in accordance with a preferred embodiment of the present invention; and

FIG. 7 is an enlarged view illustrating the crimping of the header to the footer of the tank in accordance with another preferred embodiment of the present invention.

### DETAILED DESCRIPTION OF THE PREFERRED EMBODIMENT(S)

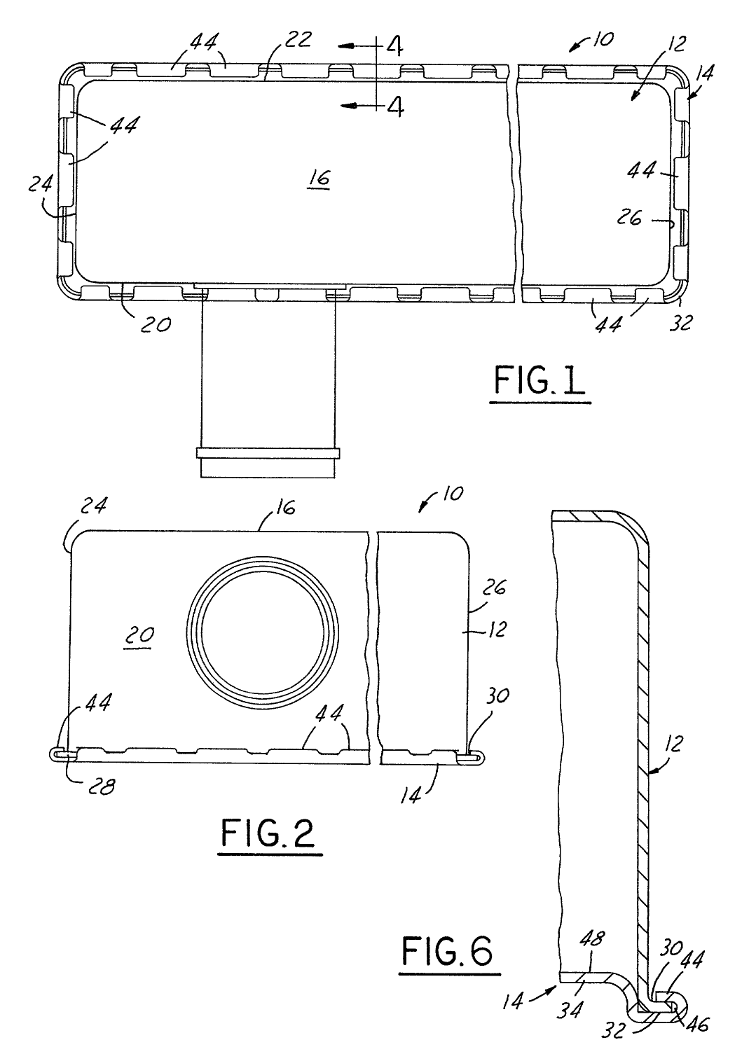

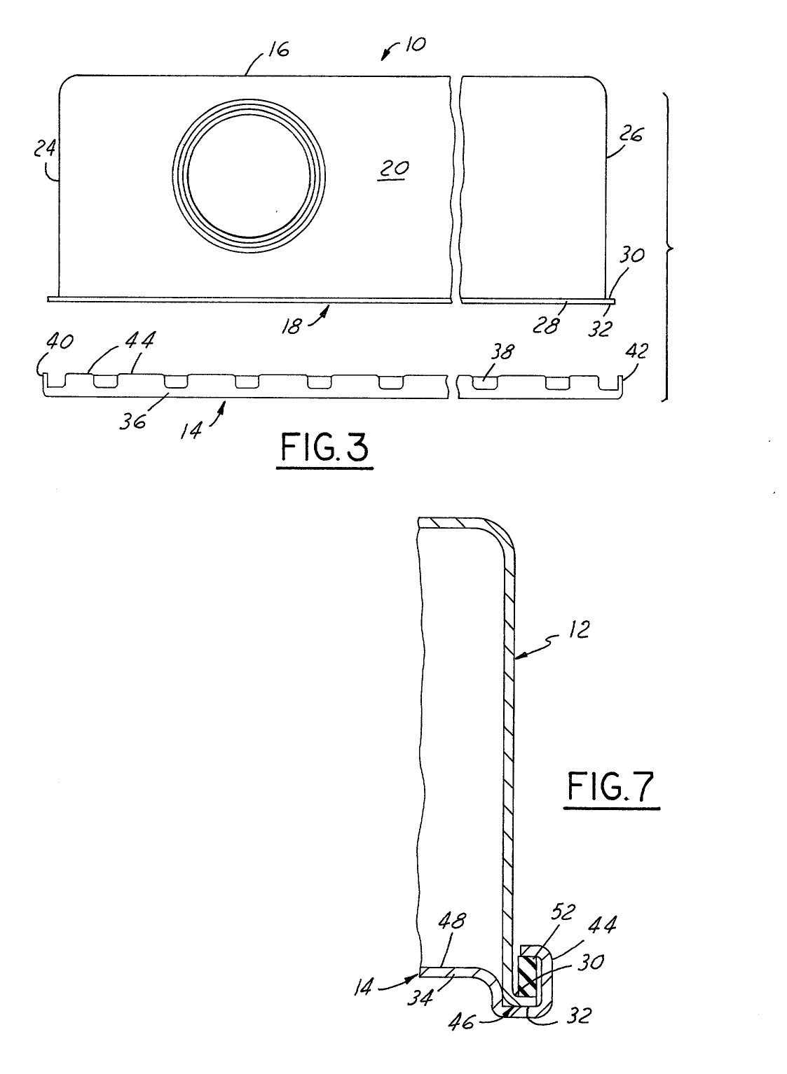

Referring now to FIGS. 1 through 5, which illustrate a heat exchanger in accordance with a preferred embodiment of the present invention. The preferred heat exchanger can be utilized in a variety of applications, including automotive radiators, heater cores, air coolers, and other automotive and nonautomotive applications.

The heat exchanger 10 includes a metal tank 12 and a header 14, which is physically retained on the metal tank 12, as discussed in more detail below. The tank 12 is preferably a stamped aluminum part that is formed during a multiple stage stamping operation. However, the tank may alternatively be cast, custom fabricated or extruded. The process by which the metal tank is formed is not critical. The tank may also be formed of a variety of materials, including, steel, stainless steel, brass, aluminum, as well as various combinations of the above and other materials. The header 14 is also preferably an aluminum part, however, the header may also be made from a variety of materials, including the same materials described above in connection with the tank 12.

As shown, the metal tank 12 has a top surface 16, a bottom surface 18, a front surface 20, a rear surface 22, and a pair of opposing side surfaces 24, 26. The front surface 20, the rear surface 22, and the pair of opposing side surfaces 24, 26 are preferably generally planar and extend upward in a generally perpendicular direction from the bottom surface 18 to form a deep-walled tank. The metal tank 12 also has an outwardly extending foot 28 that is integrally formed therewith. The foot 28 preferably extends around the entire periphery of the tank 12 and preferably extends generally perpendicular to the tank outer surface. It should be understood that instead of a single foot, a plurality of individual feet could extend around and be spaced about the periphery of the tank 12. Moreover, the foot 28 could also extend outward and slightly upward, downward, or be curved. The tank foot 28 has an upper surface 30 and a lower surface 32.

The header 14 has bottom surface 34, a front surface 36, a rear surface 38, and a pair of opposing side surfaces 40, 42. The front surface 36, the rear surface 38, and the pair of opposing side surfaces 40, 42 each extend upwardly in a generally perpendicular direction from the bottom surface 34. The front surface 36, the rear surface 38, and the pair of opposing side surfaces 40, 42 each have a plurality or crimping tabs 44 formed thereon. The crimping tabs 44 allow the header 14 to be fixedly secured to the foot 28 of the metal tank 12. The crimping tabs 44 are preferably formed on the front surface 36, the rear surface 38, and the pair of opposing side surfaces 40, 42 of the header 14. The header 14 preferably also has an internal channel 46 formed in its bottom surface 34 thereof, such that an island 48 is formed in the center thereof. It should be understood that the header 14 preferably has an island 48 formed therein, however headers 14 without islands may also be utilized.

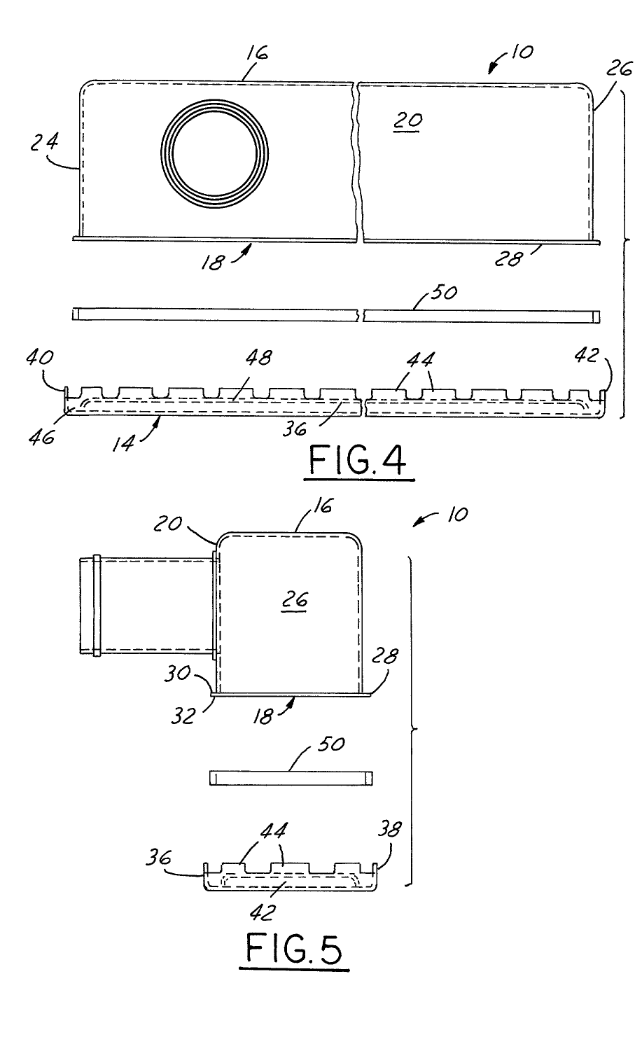

The internal channel 46 is intended to receive the foot 28 of the metal tank 12 therein when assembled. As shown in FIGS. 4 and 5, a sealant such as a gasket 50 can be located between the lower surface 32 of the tank foot 28 and the internal channel 46 of the header 14. Alternatively, another sealant such as an adhesive, brazing pre-form, or other filler may be utilized. Further, a spacer 52 (FIG. 7) may also be positioned between the crimping tab 44 and the upper surface 30 of the tank foot 28, when assembled.

The preferred heat exchanger 10 allows for the use of a current header design with or without a spacer or insert or for the use of a new generation header design with or without the use of additional inserts. As shown in FIG. 6, one method for attaching the metal tank 12 to the header 14 is shown. In this embodiment, the metal foot 28 of the tank 12 is located in the internal channel 46 formed in the header 14. Thereafter, the crimping tabs 44 are folded around the foot 28 such that they contact its upper surface 30. This assures proper contact and alignment of the components prior to sealing. The assembly, is then preferably sealed, such as through brazing. As discussed above, a variety of other sealing processes may be utilized. Moreover, a variety of methods for crimping the metal tank 12 and the header 14 may also be utilized. It should be understood that a sealant, such as a gasket 50, may be located between the lower surface 32 of the tank foot 28 and the internal channel 46.

FIG. 7 illustrates another method for attaching the metal tank 12 to the header 14. In FIG. 7, the metal foot 28 of the tank 12 is located in the internal channel 46 formed in the header 14. Thereafter, the connection is sealed by positioning the spacer 52 on the upper surface 30 of the foot 28 around the entire perimeter of the foot 28. After the spacer 52 has been positioned, the crimping tabs 44 are then folded around the foot 28 to contact the spacer 52. This configuration also assures proper contact and alignment of the components prior to sealing and is an alternative to brazing. Again, various methods for crimping as well as various sealing methods may be utilized. Each of the methods along with the preferred design allows current radiator core headers to be quickly and efficiently integrated with current manufacturing processes, thereby producing a rapid and cost effective transition.

The sealing process may be accomplished by a variety of known joining methods, such as using a gasket, adhesive, soldering, or brazing with a variety of binders, including single or multi-cladded materials and/or pastes. The heat exchanger 10 preferably utilizes a stamped aluminum tank, which is crimped to an aluminum radiator core. The assembled heat exchanger is then preferably brazed. It should be understood that for some applications, the core could be brazed first, prior to crimping the tank to the core, thereafter the entire assembly could be brazed. Alternatively, in other applications, the tank could be crimped to a non-brazed core initially, followed by brazing the entire assembly. Additionally, brazing of the tank may also require a variety of single or multi-cladded materials or the use of brazing powders or pastes, depending upon the application, as would be understood by one of skill in the art. Additionally, in another application, the tank can be made from a stamped brass, which would then be crimped to a copper and brass core and then soldered. Further, in yet another application, a stamped brass tank is crimped to a copper and brass core and then brazed.

In accordance with the preferred embodiments described above, the components such as filler necks, connectors, and brackets would be fabricated as separate pieces and then joined to the tank. This requires additional labor than an injection molded tank, however, the cost difference is likely nominal. The present invention provides significant advantages, however, by providing a significantly more durable product which minimizes in-service failures at the connectors due to cracking, minimizes in-service failures due to leaking gaskets, reduces the overall leak rate in the manufacturing process, and reduces the overall cost. Further, the disclosed invention, provides an environmental advantage by utilizing either an all aluminum or all copper and brass construction (homogenous materials), which simplifies and eases the ability to recycle the respective heat exchanger and therefore further reduces the cost.

While preferred embodiments of the invention have been described here and above, those of ordinary skill in the art will recognize that these embodiments may be modified and altered without departing from the central spirit and scope of the invention. Thus, the embodiments described here and above are to be considered in all respects as illustrative and not restrictive, the scope of the invention being indicated by the appended claims, rather than by the foregoing descriptions, and all changes which come within the meaning and range of equivalency of the claims are intended to be embraced herein.

What is claimed is:

1. A heat exchanger comprising:
a metal tank having an upper portion and a lower portion;
an integral foot formed around a periphery of said lower portion of said metal tank;
said integral foot having an upper surface and a lower surface; and
a header having a plurality of crimping tabs formed about its periphery, each of said plurality of crimping tabs foldable so as to lie above and generally parallel to said upper surface of said integral foot to retain said metal tank.

2. The heat exchanger as recited in claim 1, wherein one or more of said plurality of crimping tabs contact said upper surface of said integral foot to retain said metal tank in position with respect to said header.

3. The heat exchanger as recited in claim 1, further comprising:
a spacer disposed between said upper surface of said integral foot and an underside of said crimping tabs.

4. The heat exchanger as recited in claim 2, wherein the heat exchanger is brazed to provide a leak-free connection between said foot and said crimping tabs.

5. The heat exchanger as recited in claim 1, wherein said header has an internal channel formed therein adjacent its periphery for receipt of said integral foot therein.

6. The heat exchanger as recited in claim 8, further comprising a sealant disposed between said lower surface of said integral foot and said internal channel.

7. The heat exchanger as recited in claim 1, wherein said metal tank is comprised of a stamped aluminum material.

8. The heat exchanger as recited in claim 1, wherein said header is comprised of an aluminum material.

9. A method of forming a heat exchanger comprising:
forming a metal end tank with an integral foot portion, said foot portion having an upper surface and a lower surface;
forming a header with a plurality of crimping tabs;
locating said metal end tank in said header;
folding said crimping tabs around said integral foot portion to secure said metal end tank to said header; and
joining said crimping tabs to said integral foot portion.

10. The method of claim 9, wherein step of sealing includes brazing the heat exchanger.

11. The method of claim 9, wherein said crimping tabs directly contact said upper surface of said integral foot portion.

12. The method of claim 9, further comprising:
inserting a spacer between said upper surface of said foot portion and an underside of said crimping tabs.

13. The method of claim 9, wherein said step of forming comprises stamping said metal end tank from an aluminum material.

14. The method of claim 9, further comprising:
forming an internal channel in said header which is intended to receive said foot portion therein.

15. The method of claim 14, further comprising:
locating a sealant between said lower surface of said foot portion and said internal channel.

16. A heat exchanger comprising:
a metal tank having an integral foot portion disposed about aT least a portion of the periphery thereof;
a header having a plurality of crimping tabs for engagement with said foot portion, said header having a channel formed therein for receipt of said foot portion.

17. The heat exchanger of claim 16, further comprising a spacer disposed between an upper surface of said integral foot and an undersurface of said crimping tabs.

18. The heat exchanger of claim 16, wherein an underside of said crimping tabs contacts an upper surface of said integral foot.

19. The heat exchanger of claim 16, wherein the heat exchanger is brazed to provide a leak-free connection between said foot and said crimping tabs.

20. The heat exchanger of claim 16, wherein said metal tank is comprised of a stamped aluminum material.
